(19) United States
(12) Patent Application Publication
(10) Pub. No.: US 2005/0247261 A1
(43) Pub. Date: Nov. 10, 2005

(54) Orbiting wire accumulator

(76) Inventors: Harold James Hattersley JR., Brick, NJ (US); Peter Emerich Fortoloczki, Jersey City, NJ (US)

Correspondence Address: DECHERT LLP, P.O. BOX 10004, PALO ALTO, CA, 94303, US

(21) Appl. No.: 11/178,009

(22) Filed: Jul. 8, 2005

Related U.S. Application Data
(63) Continuation-in-part of application No. 10/973,225, filed on Oct. 25, 2004.
(60) Provisional application No. 60/516,066, filed on Oct. 30, 2003.

(51) Int. Cl. H01B 13/14

(52) U.S. Cl. 118/68; 242/360

(57) ABSTRACT

A wire accumulator is used in wire manufacturing such as wire insulation lines or bare wire manufacturing. Wire collection on an accumulator allows the wire manufacturing process to continue even during basket switching. The orbiting motion of such accumulator produces controlled wire collection pattern formation, where in the preferred instance the geometric pattern is the pedal lay pattern.

### REFERENCE TO EARLIER APPLICATION

This application is a continuation-in-part (CIP) of and incorporates by reference U.S. patent application Ser. No. 10/973,225, filed Oct. 25, 2004, entitled “AUTOMATED SCRAP WIRE REMOVAL METHOD AND APPARATUS,” which claims benefit from U.S. Provisional Application Ser. No. 60/516,066, filed Oct. 30, 2003, also entitled “AUTOMATED SCRAP WIRE REMOVAL METHOD AND APPARATUS.”

### FIELD OF INVENTION

This invention relates to wire manufacturing equipment and more specifically to wire accumulator modules in wire manufacturing equipment.

### BACKGROUND

It is a common practice to package insulated and bare wire in a basket, such as steel basket, for subsequent pay off into a wire manufacturing equipment for wire harness assembly or other operation. During normal wire manufacturing operation the insulated wire drops down from a vertical coiler and collects in the basket, and as it collects in the basket it forms a geometric pattern. A geometric wire pattern such as the pedal lay pattern facilitates easy, tangle free pay off into the next wire manufacturing process.

This process of collecting wire in the basket works continuously until the basket is filled and must be replaced with an empty basket. Replacing the basket requires human intervention and it takes time. Even so, the wire manufacturing process cannot stop while a full basket is replaced with an empty one. Therefore, there is a need to collect the wire until the new basket is in place. However, as the wire drops down from a coiler and collects it tends to form a random pattern. When it eventually drops into the empty basket the collected wire remains in this random (chaotic) form and tends to tangle during pay off into the next wire manufacturing equipment. Untangling the wires requires suspension or causes delay in the pay off and this interferes with the wire manufacturing process. Accordingly, there is a need to address the problem of a wire collecting in a random pattern during basket replacement.

### SUMMARY OF THE INVENTION

The present invention addresses these and related needs. In particular, the present invention offers a new approach to collecting wire in connection with basket switching. The new approach facilitates collection of the wire in a controlled manner that forms a geometric pattern such as the pedal lay pattern. When the collected wire drops to the basket it tends to maintain its geometric pattern, thereby providing the benefit of easy, tangle free pay off from the basket. The clear benefit that follows from this approach is more efficient, substantially uninterrupted operations.

In accordance with principles of the present invention, an orbiting wire accumulator system and method of operation are designed to produce the controlled wire accumulation pattern formation. Such system and method are provided in accordance with the purpose of the invention as embodied and broadly described herein.

One such system is an orbiting wire accumulator. The orbiting wire accumulator includes an accumulator with pallets capable of switching between open and closed positions for collecting wire in the closed position, an orbit drive mechanism, and a driven rotating link coupling between the orbit drive mechanism and the accumulator. The driven rotating link is configured to rotate when the orbit drive mechanism is running. Then, rotation of the driven rotating link produces an orbiting motion of the accumulator that causes wire to accumulate thereon in a geometric pattern formation. In this instance, the geometric pattern is a pedal lay pattern.

The orbiting wire accumulator further includes idle rotating links, three in this case, which are coupled to the accumulator and are configured to move in tandem with the driven rotating link. Together with the driven rotating link they form a four-offset rotating link for orbiting the accumulator and producing the pedal lay pattern.

Typically, the orbiting wire accumulator includes in the orbit drive mechanism a motor, a timing belt and a gear box which engage a four-offset rotating link of the accumulator for transferring rotation force from the motor to the accumulator. The rotation force of the motor produces an orbiting motion of the accumulator that causes the insulated wire to accumulate thereon in the pedal lay pattern formation.

Note that every wire coiler has an accumulator, be it in a bare or insulated wire manufacturing equipment. Specifically, in addition to an assembly for dispensing wire to a basket, each coiler has an accumulator, preferably, an orbiting accumulator, for intercepting the wire during basket switching. In each coiler, the orbiting accumulator includes means for collecting wires, orbit drive means, and link means for transferring rotation force from the orbit drive means to the wire collecting means. The rotation force produces an orbiting motion of the wire collecting means which causes the wire to accumulate thereon in the desired geometric pattern formation.

In a wire manufacture system such as a wire insulation line that includes a wire payoff, a wire insulator, and a basket for receiving the insulated wire, the accumulator is deployed for collecting insulated wire in connection with basket switching. Not every wire insulation line has a scrap wire removal module but each wire insulation line has a coiler and, therefore, every wire insulation line has an accumulator.

Also, in a method for automatically collecting wire on an accumulator, start and stop commands control the orbiting operation of the accumulator. In particular, the method includes guiding wire through an accumulator, wherein the wire falls to and collects in a basket. The first command directs the accumulator to start orbiting and collect wire, that continues to descend on it, in response to an indication that the basket is full. The wire collecting on the orbiting accumulator forms a geometric pattern such as the pedal lay pattern. The second command directs the accumulator to stop orbiting and let the accumulated wire fall through in response to an indication that an empty basket is ready to receive wire. The commands to start and stop orbiting include activation of an orbit drive mechanism that engages a four-offset rotating link for transferring rotation force from the orbit drive mechanism to the accumulator. As mentioned, the rotation force produces the orbiting motion of the accumulator for collecting the wire in the geometric pattern formation.

As can be appreciated, this approach has the advantage of producing controlled wire accumulation patterns and, thereby, tangle-free wire pay off. This and other features, aspects and advantages of the present invention will become better understood from the description herein and accompanying drawings.

### BRIEF DESCRIPTION OF THE DRAWINGS

The accompanying drawings which are incorporated in and constitute a part of this specification illustrate various aspects of the invention and together with the description serve to explain its principles. The drawings are briefly described as follows:

FIG. 1 illustrate a wire insulation system;

FIG. 2 illustrates a wire coiler that embodies a wire accumulator;

FIGS. 3A, 3B are top and side views of a conceptual accumulator plate, respectively;

FIGS. 4A-G include a set of diagrams of an orbital accumulator assembly, providing left, right, top, bottom, front, back and isometric, views of this assembly;

FIGS. 5A-C include a set of diagrams showing exploded views of another orbital accumulator assembly, showing the accumulator assembly, the idle crank arm and the drive; and

FIG. 6, parts 1 and 2, is a diagram of the accumulator assembly in orbital motion.

### DETAILED DESCRIPTION OF THE INVENTION

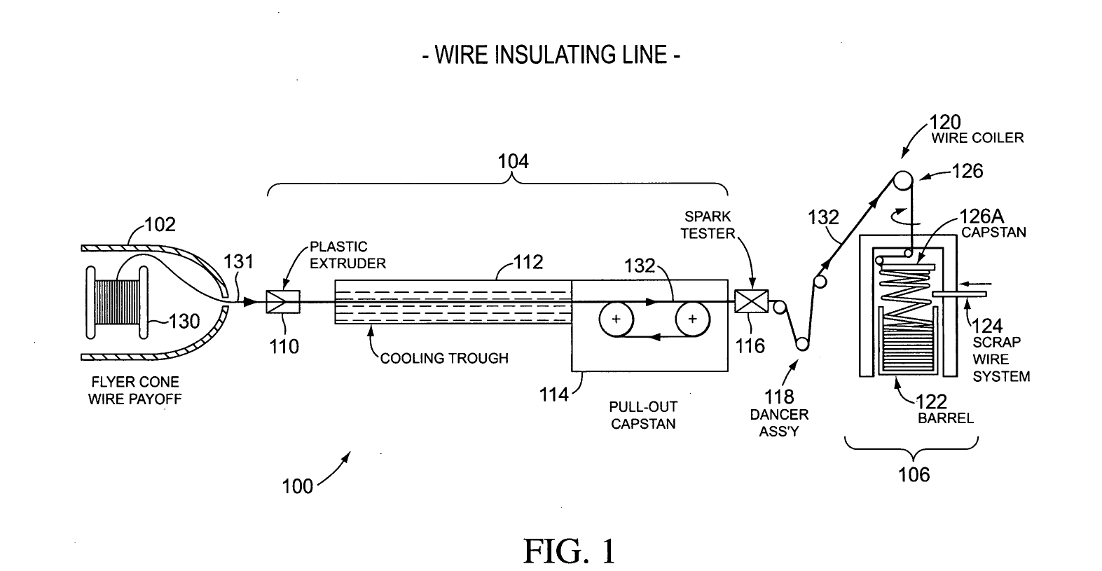

To more fully automate the process in wire manufacturing such as wire insulation lines, the present invention offers a new approach for collecting wire in connection with basket switching and scrap wire removal operations. The new approach provides controlled wire collection pattern formation where wire collection forms a geometric pattern such as the pedal lay pattern. When the collected wire drops to the basket it tends to maintain its geometric pattern. Note that all coilers, whether in bare or insulated wire manufacturing equipment, have an accumulator. In order to better understand the principles of the invention, it is described first in the context of a wire insulation line as shown in FIG. 1 (the so called “wire insulation system”).

In general, a typical wire insulating line consists of a bare wire payoff device 102, the insulation equipment 104, and a coiler 120. As shown in more detail in FIG. 1, a wire insulation system preferably includes: a bare wire payoff mechanism 102, an extruder 110, a cooling means 112, a pull-out capstan 114, a spark tester 116, a dancer 118, a wire scrap removal module 124, and an insulated wire take-up mechanism also referred to here as the coiler 120. In addition, there are one or more wire reels (e.g., 130), wire baskets or baskets 122, and scrap wire containers (not shown). Note that while coilers work with both bare and insulated wire, scrap removal systems work only with insulated wire to remove defective segments of the insulated wire.

The wire payoff mechanism 102 is constructed for paying off wire from a reel (or spool) 130, preferably in a controlled manner. For example, after the reel is placed into a payoff position, a wire tensioner is engaged to maintain wire tension and ensure continuous payoff. Optionally, one or more guide bars are engaged with the wire to keep it from jumping off the rollers as it is moved through toward the extruder.

On the way out from the extruder, the insulated wire is cooled in a cooling area 112 and tensioned in the pull-out capstan (or simply capstan) 114. The axis of the capstan 114 is preferably in a horizontal plane.

The coiler 120 is a mechanism for packaging the wires into baskets 122. Note that although the system can accommodate any container suitable for collecting wires, for simplicity, we refer to all types of wire containers as baskets. While the payoff 102 feeds the bare wire 131 to the insulating line equipment, the coiler 120 “takes-up” the insulated wire 132 in baskets 122. In the coiling process, the insulated wire 132 is continuously presented to the coiler at process speeds. This speed can, in one instance, range from 1,000 feet per minute to 8,500 feet per minute.

At the coiler 120, a rotating flyer assembly wraps the wire around a stationary capstan 126 while the dancer 118 provides the static or variable tension in the wire 132 as it is presented to the coiler. The convolutions (loops) of insulated wire are wrapped radially along the surface of the capstan 126A by a deflector roller that rotates together with the flyer Assembly. When the convolutions are displaced beyond the cylindrical surface of the capstan, because capstan axis is preferably in a vertical plane, they fall under by the action of gravity toward a basket 122 located directly below the capstan 126A.

Although not shown in this diagram, the basket can be offset while it is rotated. Offsetting the basket while rotating it causes the wire collecting in the basket to form the geometric pattern referred to as the pedal lay pattern.

This process works continuously until the basket is filled up. A new basket replaces the old one when the old basket is full. In order to make the basket switch with minimal interruption, an accumulator intercepts and collect the descending loops of wire, allowing time to replace the full basket with an empty one. In other words, the accumulator is ‘activated’ when the basket switch is about to begin and ‘deactivated’ when the operator completes the basket switch.

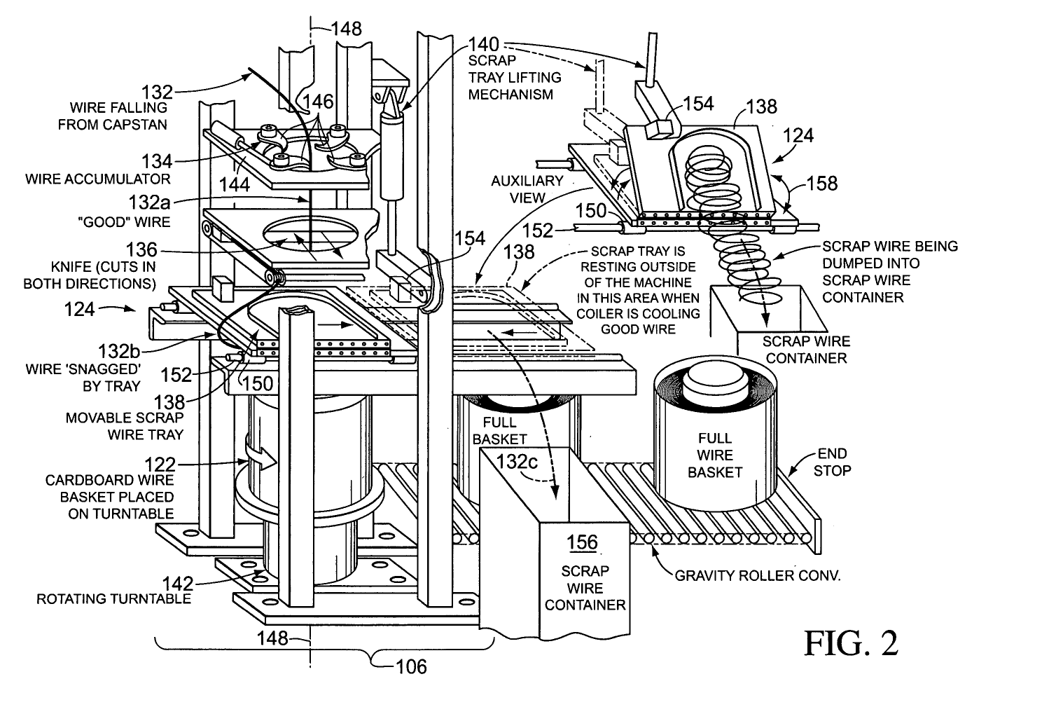

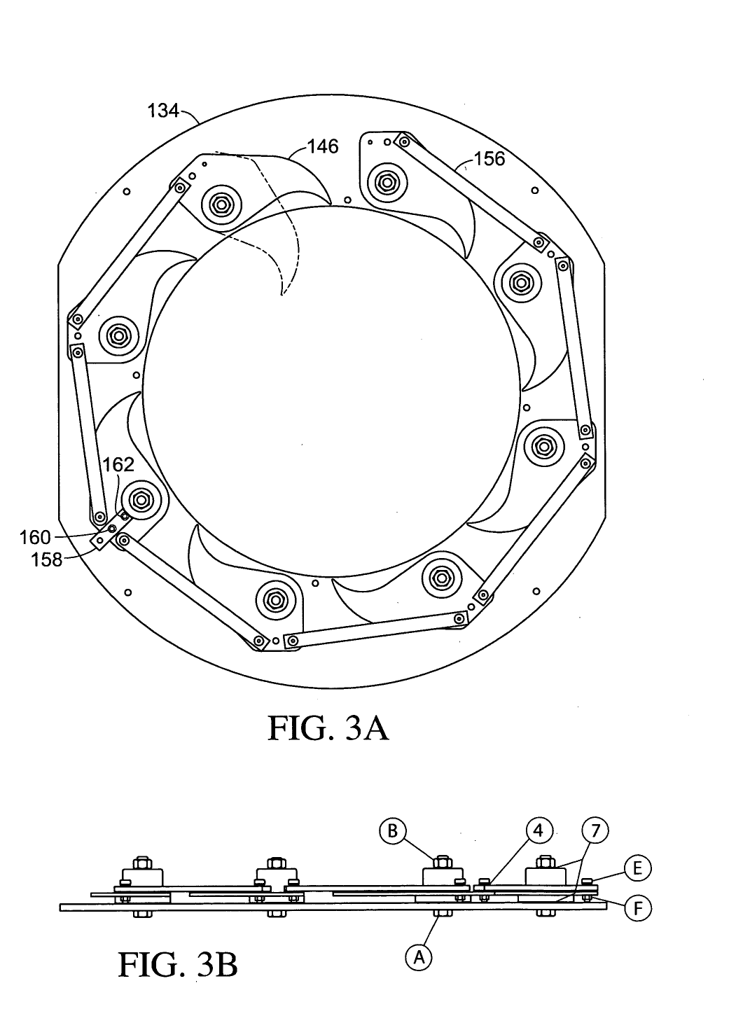

One example of a wire coiler embodying an accumulator is provided in FIG. 2. Not every wire insulation line has a scrap wire removal module but each wire insulation line has a coiler and, therefore, every wire insulation line has an accumulator. In this example, when the accumulator 134 is ‘activated’ its pallets 146 close and lasso the wire. When the accumulator is ‘deactivated’ the pallets 146 open and wire loops that collected on the accumulator 134 drop down into the empty basket. Again, although this is a coiler in a wire insulation line (such as that of FIG. 1), every coiler, whether in insulated or bare wire manufacturing equipment, has a wire accumulator. Therefore, this example is not to be viewed as limiting the present invention to wire insulation lines. Any type of wire manufacturing equipment with a coiler has an accumulator.

In each coiler, however, the wire loops accumulating during the basket switch period tend to form a random pattern on the accumulator and fall into the basket with about the same random shape as they formed on the accumulator. Chaotic bundles of wires loops tend to tangle during pay off into the next wire manufacturing equipment and untangling the wires causes delay and may even require suspension of the pay off.

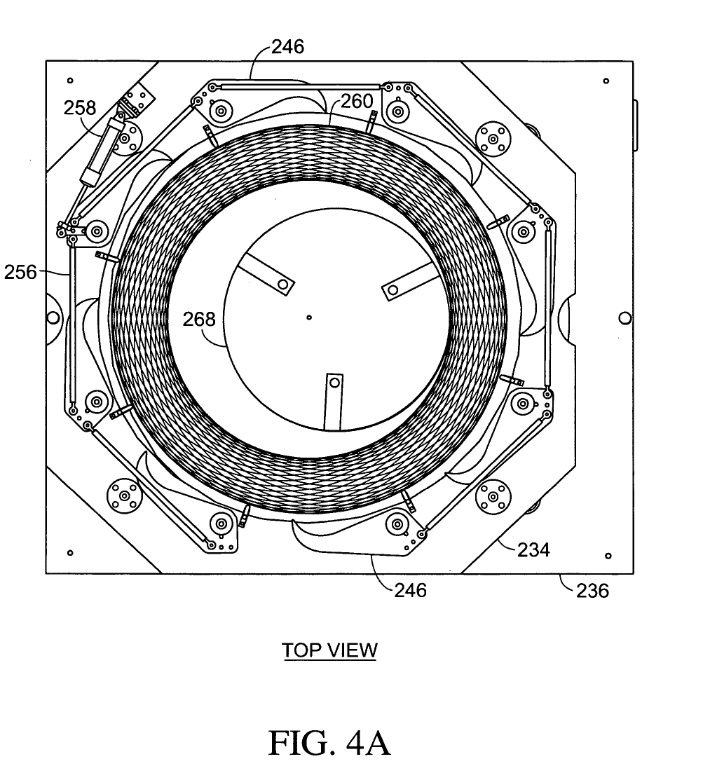

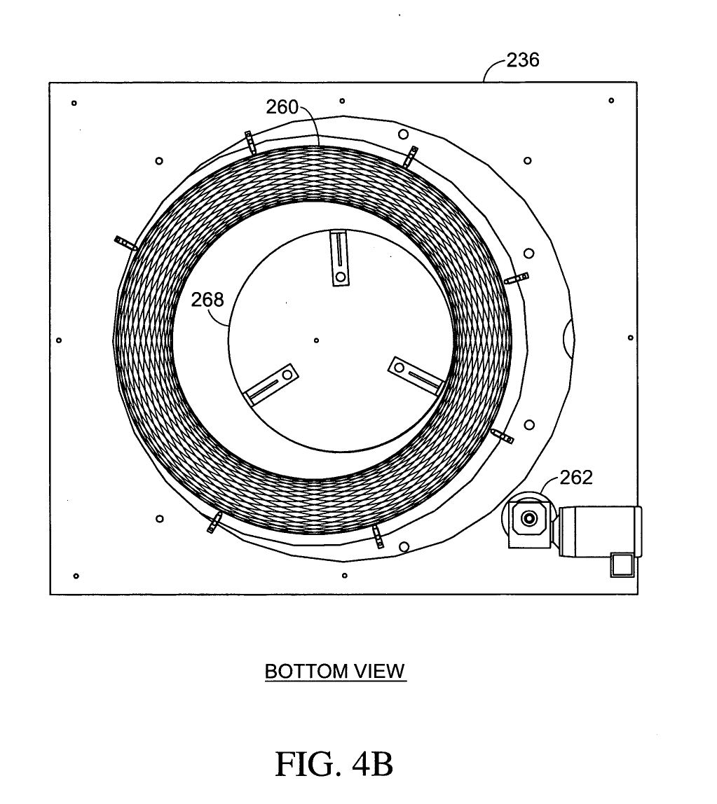

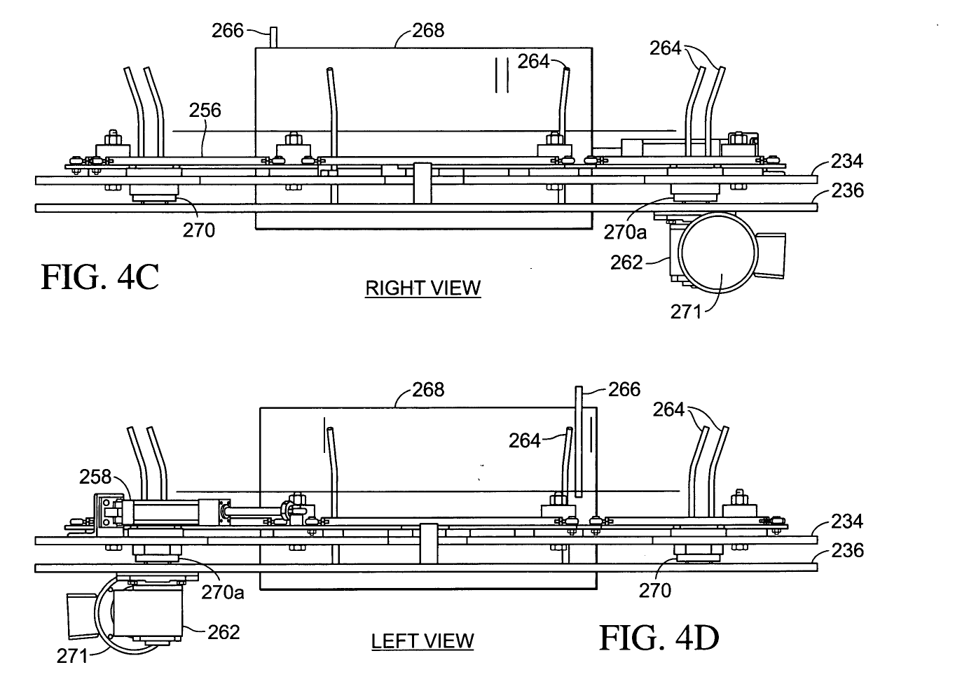

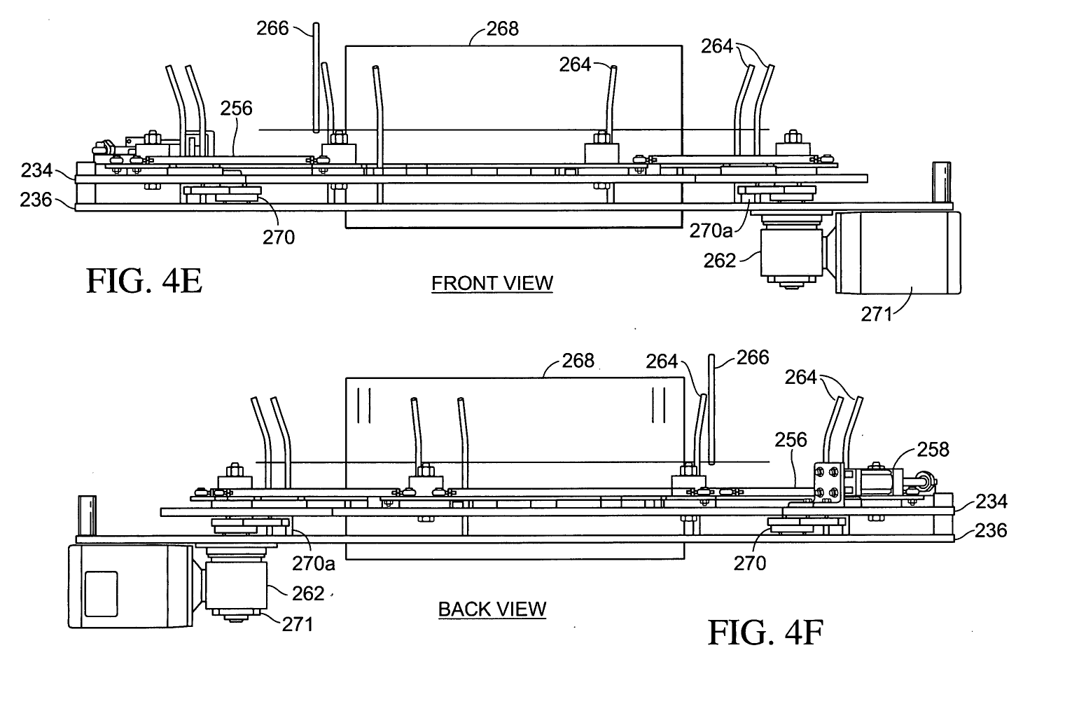

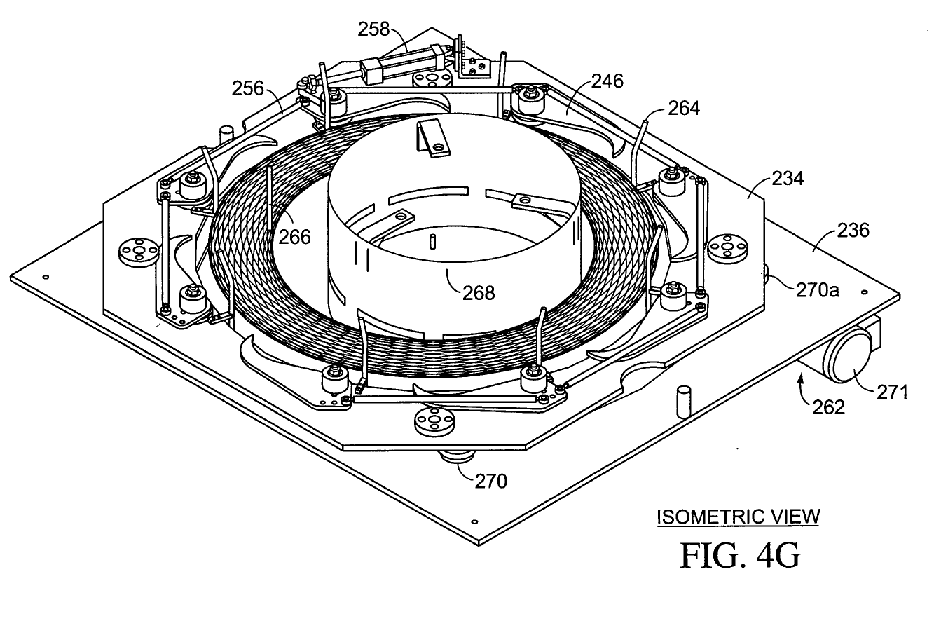

The present invention provides a solution to this problem that entails more control over wire collection on the accumulator, preferably where the wire loops form a geometric pattern as they descend and collect on the accumulator. Preferably also, wire collection on the accumulator forms the same geometric pattern as that of the wire collecting in the basket, say, pedal lay pattern. Accordingly, in a preferred embodiment the accumulator is designed as an orbiting wire accumulator to replace the stationary accumulator and allow formation of the pedal lay pattern. FIGS. 4A-4G show different views of an orbiting accumulator: right, left, top, bottom, front, back and isometric.

In operation, the orbiting accumulator continues to collect the wire as before. However, when the start of a basket change is indicated, the accumulator switches to orbiting mode where it orbits as it collects the wire loops to produce the pedal lay pattern formation. This orbiting motion is achieved with a drive motor and a four-offset link mechanism where one of the rotating links is coupled to the drive motor via a timing belt and gear box. The amount of offset dictates the size of the pedal lay pattern and is matched to what would be the offset of the rotating basket below. When the basket exchange is complete the orbiting accumulator stops orbiting, switching to its normal resting mode. To work more properly, the accumulator starts and stops orbiting from the same position, centered over the basket. This is achieved with proximity sensors at the start/stop position. These operations are performed by an accumulator configured as described below.

FIG. 4A is the top view of an orbiting wire accumulator. The orbiting accumulator plate 234 is shown resting above the stationary plate 236 and holding a bundle of wire loops collected thereon in a pedal lay pattern formation 260. The pallets 246 are shown retracted (open) which means that the collected wire 260 can now fall through to the basket below. Note that as the accumulator is activated the hook shape of the pallets 246 allows them to retract sufficiently to avoid wire loops hang-up, namely, wire loops getting caught by the pallets. Moreover, the hook shape of the pallets facilitates easier packaging of the pallets under the accumulator plate. The pallets 246 are pivotally connected to their respective neighbor pallets via rods 256. Motion of the pallets between open and closed position is controlled by the rods and a drive mechanism 258 that is connected to them. In this particular implementation, the drive mechanism 258 is pivotally coupled to a fixed point at one end and, directly or indirectly, to one of the rods or pallets at the other end. As the drive mechanism extends it moves the rods 256 in a counterclockwise direction and causes the pallets 246 to swivel to an open position, and as drive mechanism retracts it moves the rods in a clockwise direction and causes the pallets to swivel to the closed position. As mentioned, the wire collects when the pallets are in the closed position.

The wire collected in a pedal lay pattern is also shown in FIG. 4B, a bottom view of the orbiting accumulator, where the inner guide drum 268 keep the inside diameter of the accumulated wire consistent (helps form the donut-shaped wire bundle 260). From this angle, the orbit drive mechanism 262 for orbiting plate 234 is shown coupled to the stationary plate 236 or frame of the accumulator. The orbit drive mechanism can be implemented as shown (direct drive) or it can be implemented another way using for instance a drive belt. More details of the orbit drive mechanism with a drive belt will be shown in subsequent diagrams.

FIGS. 4C-4F show the right, left, front and back views of the accumulator with different views of the orbit drive mechanism 262. In this accumulator configuration, the orbit drive mechanism includes a motor-driven four offset rotating link 270, one of which couples between the orbit drive motor 271 and the orbiting plate 234. The orbit drive motor 271 is connected to the driven rotating link mechanism 270a via a timing belt 273 and a gear box. This link mechanism 270a rotates with rotation of the orbit drive motor 271 and causes plate 234 to orbit accordingly. As it orbits, when the pallets 246 are closed, the accumulator plate 234 collects wire loops in a pedal lay formation. To this end, inner guide rods 266 and outer guide rods 264 are respectively dispersed along inner and outer perimeters of the accumulator plate and, along with the inner guide drum 268, operate to maintain consistent diameter of the accumulating wire loops (by arresting the effects of forces, such as centrifugal forces, on the wire loops). The number and size of inner and outer rods depends on the accumulator and wire sizes and in this instance there are 8 of each.

The isometric view in FIG. 4G shows the orbiting accumulator after having collected the wire 260 and before the wire drops to the basket below. In this position, the drive mechanism is retracted and the pallets 146 are open. From this angle, the orbit drive mechanism 262 is shown in part.

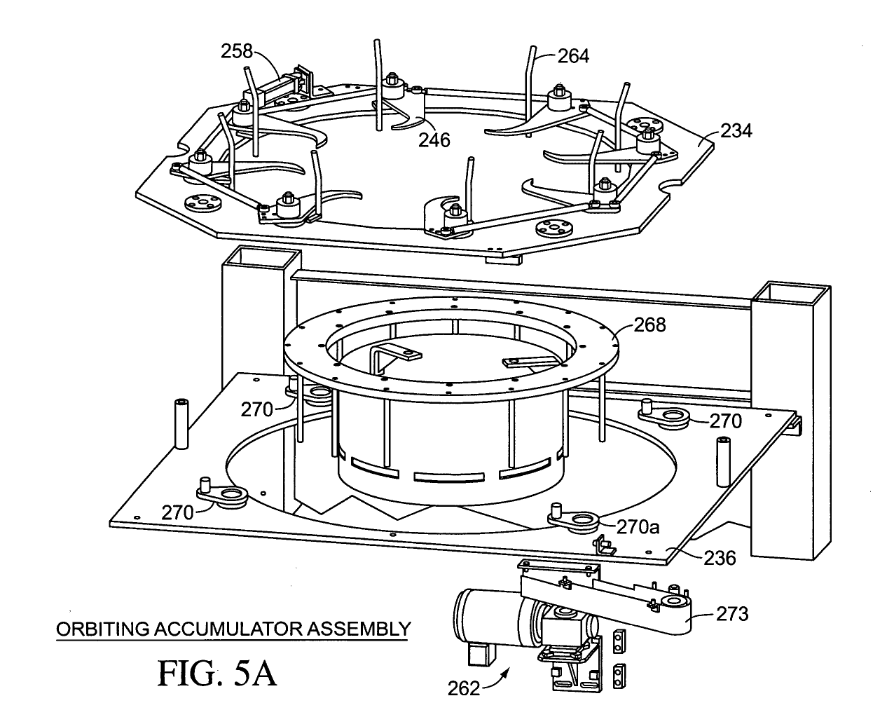

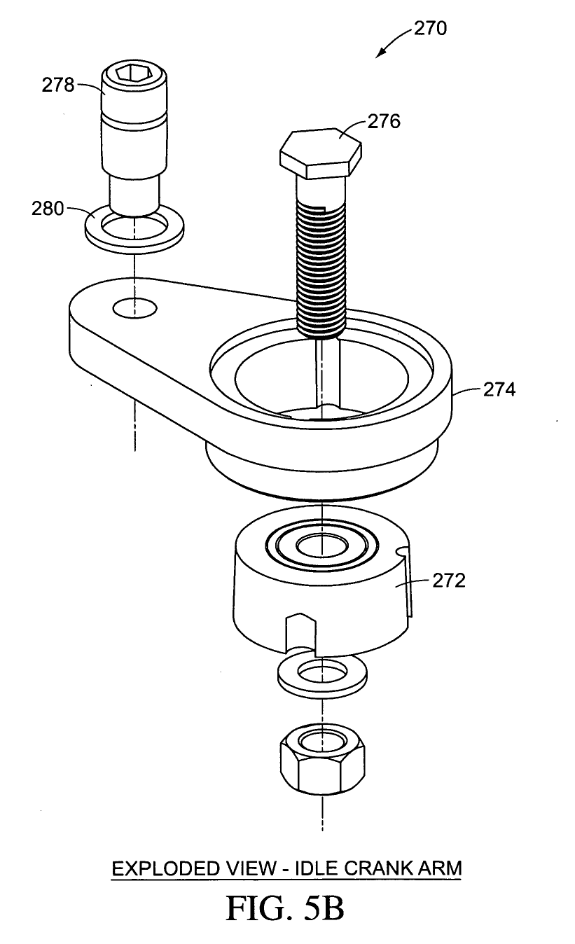

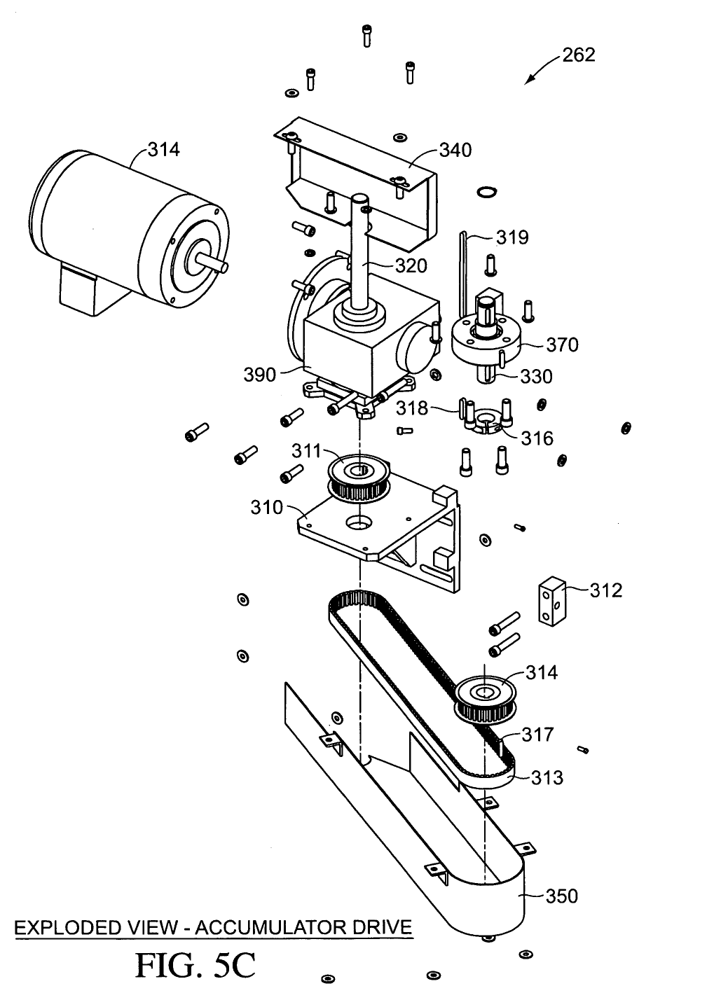

The exploded view of an orbiting accumulator assembly is shown is FIG. 5A. The orbiting accumulator plate 234 is shown detached from the frame and with the pallets 246 in a closed position. When mounted, the orbiting plate is substantially concentric with the guide drum 268 and is connected with the link mechanisms of the four-offset rotating link 270, one at each of its corners (substantially 90° apart). It is noted that, although in this configuration there are three idle link mechanisms and one driven link mechanism, for a different accumulator design the four-offset rotating link 270 may be replaced with a another link suitable for such design. The orbit drive motor 271 is mounted to the frame and connected via a gear box and timing belt 273 to the driven link mechanism 270a.

FIG. 5B provides an exploded view of an idle link arm mechanism, also referred to as the idle crank arm. In this mechanism, arm 274 is fixed to the stationary plate at its pivot point via a screw 276 and washers 272. Rod 278 is attached to the arm 274 at an opposing pivot point and facilitates connection to the orbiting plate 234.

FIG. 5C provides an exploded view of an orbit drive motor assembly. The timing belt 313 to which the driven link mechanism 270a is connected has a protective housing 350 and a rotation guide 314. The shaft of a drive motor 314, such as an AC motor, is connected to the gear box 390 and drives the timing belt via the shaft 320 and belt guide 314.

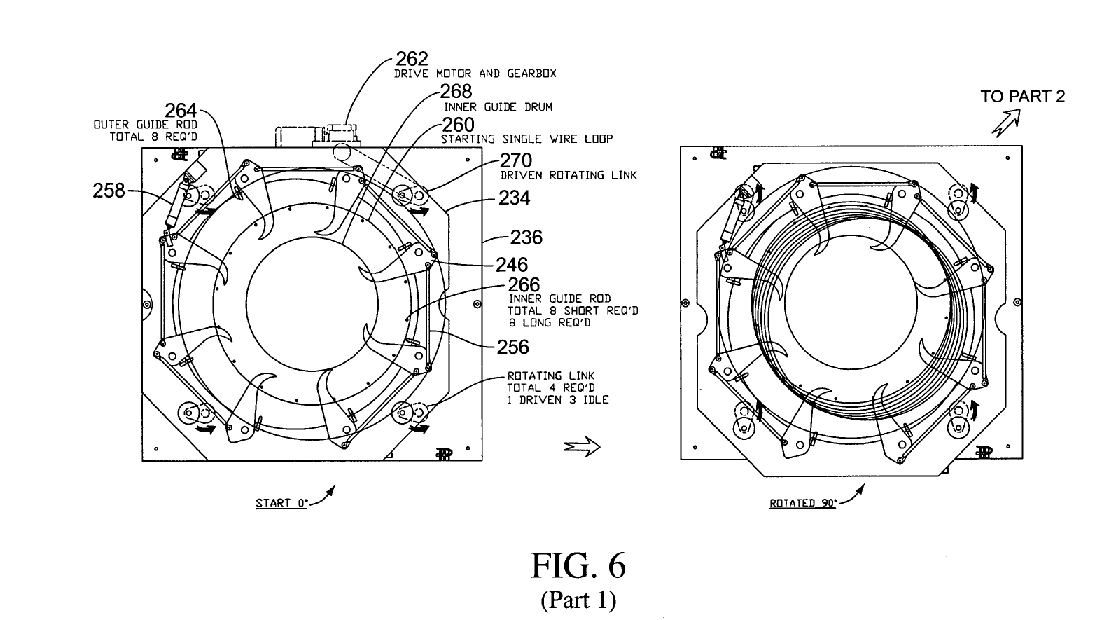

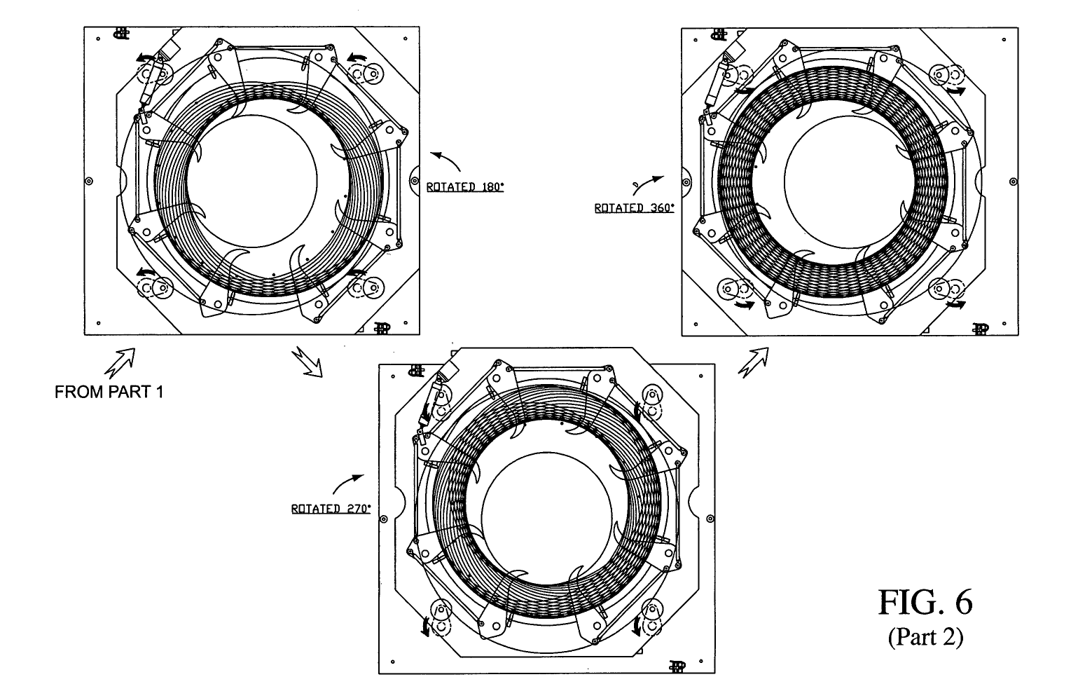

With this configuration, an orbiting accumulator rotates in a manner shown in FIG. 6, parts 1 and 2. With its pallets 246 closed, the orbiting accumulator starts at 0° and, in succession, orbits to 90° and then to 180° and 360°. In each stage of the orbit, the arrows show the direction of the four-offset rotating link movement to the next stage. For instance, at 0° the arrows show 90° rotation of the four-offset rotating link 270 counterclockwise (quarter circle) around its pivot point, which translates to movement of the orbiting plate 234 down and to the right. From the 90° stage, the arrows show further 90° rotation counterclockwise of the four-offset rotating link, which translates to movement up and further to the right of the orbiting plate 234. From the 180° stage, the arrows show further 90° rotation counterclockwise of the four-offset rotating link 270 and a corresponding movement of the orbiting plate 234 up and to the left. From the 270° stage, the arrows show further 90° rotation counterclockwise of the four-offset rotating link 270 and a corresponding movement of the orbiting plate 234 down and to the right. This movement takes the orbiting plate to the 360° stage which is also the 0° stage. The extent of each of these movements is dictated by the offset and, in turn, by the configuration of the link arms. Moreover, rotation of the four-offset rotating link is controlled by the driven rotating link 270a, which is, in turn, controlled by the orbit drive motor.

In sum, the orbiting motion of the accumulator as shown and described above produces the controlled wire collection pattern formation, where in the preferred instance the geometric pattern is the pedal lay pattern. However, although the various aspects of the present invention have been shown and described in considerable detail with reference to particular implementations thereof, other implementations are possible. Therefore, the spirit and scope of the present invention should not be limited to the illustration and description of the embodiments contained herein.

1. An orbiting wire accumulator, comprising:
an accumulator with pallets capable of switching between open and closed positions for collecting wire in the closed position;
an orbit drive mechanism; and
a driven rotating link coupling between the orbit drive mechanism and the accumulator and configured to rotate when the orbit drive mechanism is running, wherein rotation of the driven rotating link produces an orbiting motion of the accumulator that causes wire to accumulate thereon in a geometric pattern formation.

2. An orbiting wire accumulator as in claim 1, wherein the geometric pattern is a pedal lay pattern.

3. An orbiting wire accumulator as in claim 1, further comprising an idle rotating link coupled to the accumulator and configured to move in tandem with the driven rotating link and together with the driven rotating link form an offset rotating link for orbiting the accumulator.

4. An orbiting wire accumulator as in claim 3, wherein the offset rotating link is configured as a four-offset rotating link with the driven rotating link and three idle rotating links.

5. An orbiting wire accumulator as in claim 3, further comprising a stationary frame or plate to which idle rotating links are coupled.

6. An orbiting wire accumulator as in claim 1, further comprising an inner guide drum for maintaining an inner radius of collecting wire loops substantially consistent.

7. An orbiting wire accumulator as in claim 6, wherein the inner guide drum in the accumulator is substantially aligned with the vertical axis of a basket allowing wire to fall through into the basket.

8. An orbiting wire accumulator as in claim 1, wherein the accumulator has top and bottom surfaces, each with an opening and between them a passageway for wire.

9. An orbiting wire accumulator as in claim 8, wherein the pallets are distributed on top of the accumulator around the opening and when in the closed position the pallets are oriented to catch and prevent wire from falling through the passageway.

10. An orbiting wire accumulator as in claim 1, wherein the pallets are configured as curved hooks.

11. An orbiting wire accumulator as in claim 1, wherein the orbit drive mechanism includes a motor, a timing belt and a gear box.

12. An orbiting wire accumulator as in claim 1, further comprising inner and outer guide rods.

13. An orbiting wire accumulator as in claim 1, further comprising proximity sensors for enabling the accumulator to start and stop in a substantially similar start/stop position at or next to which the proximity sensors are located.

14. An orbiting wire accumulator as in claim 13, where in the start/stop position the accumulator is centered over a basket.

15. An orbiting wire accumulator as in claim 3, wherein dimensions of the driven and idle rotating links dictate an offset of the orbiting motion and size of the geometric pattern.

16. An orbiting wire accumulator as in claim 15, wherein the offset is substantially similar to an offset of a rotating basket located under the accumulator for receiving wire therefrom such that the geometric pattern formed by a wire collecting on the accumulator would be similar to that of a wire collecting in the rotating basket.

17. An orbiting wire accumulator, comprising:
means for collecting wires;
orbit drive means; and
link means for transferring rotation force from the orbit drive means to the wire collecting means, wherein the rotation force produces an orbiting motion of the wire collecting means that causes wire to accumulate thereon in a geometric pattern formation.

18. A wire coiler, comprising:
an assembly for dispensing wire to a basket; and
an orbiting accumulator for intercepting the wire during basket switching, the orbiting accumulator includes:
means for collecting wires;
orbit drive means; and
link means for transferring rotation force from the orbit drive means to the wire collecting means, wherein the rotation force produces an orbiting motion of the wire collecting means that causes wire to accumulate thereon in a geometric pattern formation.

19. A wire coiler as in claim 18, wherein the wire is bare or insulated.

20. A wire insulation line, comprising:
a wire payoff with a dispenser for dispensing a bare wire;
insulation means for applying insulation on the bare wire, thereby producing an insulated wire;
a basket for receiving the insulated wire;
means for scrap wire removal by isolating defective segments of the insulated wire and preventing such segments from reaching the basket; and
a coiler having an accumulator operative for collecting the insulated wire in connection with the scrap wire removal and basket switching, wherein the accumulator includes orbit drive means and link means for transferring rotation force from the orbit drive means to the accumulator, wherein the rotation force produces an orbiting motion of the accumulator that causes the insulated wire to accumulate thereon in a geometric pattern formation.

21. A wire insulation line as in claim 20, further comprising a tester having a detector and a defect indication output, the tester being operatively engaged with the insulated wire, wherein the detector asserts the defect indication if it finds a defective segment in the insulated wire.

22. A wire insulation line as in claim 20, in which the accumulator further includes hooks that are curved and oriented, in closed position, for collecting the insulated wire and, in open position, for letting the wire fall through.

23. A wire insulation line as in claim 20, further comprising a scrap tray with a tilt plate and a lift linkage operatively engaged with the tilt plate to tilt it at an angle sufficient to allow isolated defective segments to slide off the tilt plate.

24. A wire insulation line as in claim 20, wherein the coiler further includes a wire take-up assembly.

25. A wire insulation line as in claim 20, further comprising support for the basket which is rotatable in order to achieve a circular collection of the wire in the basket, wherein rotation of the basket is offset to produce a pedal lay pattern.

26. A wire insulation line as in claim 20, wherein the geometric pattern is a pedal lay pattern.

27. A method for automatically collecting wire on an accumulator, comprising:
guiding wire through an accumulator, wherein the wire falls to and collects in a basket;
commanding the accumulator, in response to an indication that the basket is full, to start orbiting and collecting wire that continues to descend on it, wherein the wire collecting on the orbiting accumulator forms a geometric pattern;
commanding the accumulator to stop orbiting and let the accumulated wire fall through in response to an indication that an empty basket is ready to receive wire,
wherein the commands to start and stop orbiting include activation of orbit drive means that engages link means for transferring rotation force from the orbit drive means to the accumulator, wherein the rotation force produces the orbiting motion of the accumulator for collecting the wire in the geometric pattern formation.

28. A method as in claim 27, wherein the geometric pattern is pedal lay pattern.
